(19) United States
(12) Patent Application Publication
(10) Pub. No.: US 2025/0181373 A1
(43) Pub. Date: Jun. 5, 2025

(54) INTERFACE AND ABSTRACTION SYSTEM FOR EDGE BARE METAL SERVICE

(71) Applicant: CenturyLink Intellectual Property LLC, Denver, CO (US)

(72) Inventors: Marcel Etchart, Atlanta, GA (US); James Sutherland, Ridgefield, WA (US)

(73) Assignee: CenturyLink Intellectual Property LLC, Denver, CO (US)

(21) Appl. No.: 18/970,148

(22) Filed: Dec. 5, 2024

Related U.S. Application Data
(60) Provisional application No. 63/606,344, filed on Dec. 5, 2023.

(51) Int. Cl. G06F 9/455; G06F 9/50; H04L 67/02; H04L 67/1001

(52) U.S. Cl. CPC G06F 9/45541; G06F 9/45504; G06F 9/5077; H04L 67/02; H04L 67/1001

(57) ABSTRACT

Novel tools and techniques are provided for implementing interface and abstraction system for edge bare metal (“EBM”) service. In various embodiments, an interface system receives first input requesting interaction with one or more EBM servers, each located at a network edge and each configured to provide bare metal server resources. The interface system provides a uniform interface between a plurality of EBM servers and external systems and establishes a connection with each EBM server. The interface system generates commands (e.g., instructions and/or queries, etc.) for each EBM server based on the first input and sends the commands to each EBM server over the corresponding established connection. The interface system accesses and abstracts data from the EBM servers via the established connection with each EBM server, generates data views based on the abstracted data, and presents the data views to a requesting system among the one or more external systems.

### CROSS-REFERENCE TO RELATED APPLICATIONS

This application claims the benefit of U.S. Provisional Application No. 63/606,344 filed Dec. 5, 2023, entitled “Interface and Abstraction System for Bare Metal Service,” which is incorporated herein by reference in its entirety.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to methods, systems, and apparatuses for implementing provisioning of network services, and, more particularly, to methods, systems, and apparatuses for implementing interface and abstraction system for edge bare metal (“EBM”) service.

### BACKGROUND

Conventionally, a single instance of a metal as a service (“MAAS”) service (such as available from Canonical Ltd.) is used to handle inventory and operation of all EBM services. Upstream systems interact directly with MAAS. Such monolithic models are simple and consistent for upstream interactions, but are not suitable for significant scaling. It is with respect to this general technical environment to which aspects of the present disclosure are directed.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. In some instances, a sub-label is associated with a reference numeral to denote one of multiple similar components. When reference is made to a reference numeral without specification to an existing sub-label, it is intended to refer to all such multiple similar components. For denoting a plurality of components, the suffixes “a” through “n” may be used, where n denotes any suitable integer number (unless it denotes the number 14, if there are components with reference numerals having suffixes “a” through “m” preceding the component with the reference numeral having a suffix “n”), and may be either the same or different from the suffix “n” for other components in the same or different figures. For example, for component #1 X05a-X05n, the integer value of n in X05n may be the same or different from the integer value of n in X10n for component #2 X10a-X10n, and so on.

FIG. 1 depicts a schematic diagram illustrating a system for implementing interface and abstraction system for EBM service, in accordance with various embodiments.

FIG. 2 depicts a schematic diagram illustrating a non-limiting example architecture for implementing interface and abstraction system for EBM service, in accordance with various embodiments.

FIG. 3 depicts a block flow diagram illustrating a non-limiting example code workflow for implementing interface and abstraction system for EBM service, in accordance with various embodiments.

FIGS. 4A-4G depicts flow diagrams illustrating a method for implementing interface and abstraction system for EBM service, in accordance with various embodiments.

FIG. 5 depicts a block diagram illustrating an exemplary computer or system hardware architecture, in accordance with various embodiments.

### DETAILED DESCRIPTION OF CERTAIN EMBODIMENTS

### Overview

Various embodiments provide tools and techniques for implementing provisioning of network services, and, more particularly, to methods, systems, and apparatuses for implementing interface and abstraction system for edge bare metal (“EBM”) service.

In various embodiments, an interface system receives first input requesting interaction with one or more EBM servers among a plurality of EBM servers. The plurality of EBM servers is each located at a network edge and is each configured to provide bare metal server resources. The interface system provides a uniform interface (in some cases, a single uniform interface) between the plurality of EBM servers and one or more external systems. The interface system establishes a connection with each EBM server of the one or more EBM servers. The interface system generates one or more commands for each of the one or more EBM servers based on the first input, and sends the one or more commands to each of the one or more EBM servers over the established connection with each EBM server. The one or more commands include at least one of one or more instructions or one or more queries. The interface system accesses and abstracts data from the one or more EBM servers via the established connection with each EBM server, generates one or more data views based on the abstracted data, and presents the one or more data views to a requesting system among the one or more external systems.

Bare metal server resources or bare metal service, as used herein, may refer to a computer networking resources or service in which each bare metal server providing the resources or service is used by a single tenant and is a distinct physical piece of hardware that is a functional server on its own, rather than virtual servers running in multiple pieces of shared hardware. Bare metal servers are unlike cloud servers or hypervisor servers, in which multiple tenants share a virtual server's compute, storage, and/or other resources. Each bare metal server may run any amount of work for a user, or have multiple simultaneous users, but they are dedicated entirely to the tenant or entity who is renting them. The tenant or the renting entity can optimize the bare metal server based on its needs for performance, security, and reliability. As used herein, a tenant refers to an individual user or a group of users who share a common access with specific privileges to an instance of software.

In examples, the interface system provides a uniform interface between an inventory of a plurality of EBM servers and a plurality of external systems, and provides an API for asynchronous interaction with an entirety of the inventory of the EBM servers. In this manner, external systems that need to interact with the inventory of the EBM servers are provided with a consistent endpoint regardless of how many, or even what type, of bare metal inventory and management systems are in use across the network or the network edge. Asynchronous interaction (e.g., using asynchronous MaaS API calls, etc.) allows for passing the MaaS API calls to each of the MaaS instances for a corresponding EBM server in a concurrent manner. This parallel processing allows for wait times in receiving a response to remain close to a length of time it takes to query the largest MaaS instance in scope. In an example, it may take 48 seconds for receiving a response for a single MaaS call, while single-threaded calls to 3 MaaS instances may take 157 seconds for responses, but asynchronous calls to 3 MaaS instances may only take 53 seconds for responses. Operations and interactions with the inventory of the EBM servers are handled through the interface system. In an example, the interface system handles any and all operations and interactions with the inventory of the EBM servers. In some examples, the interface system makes direct calls to MaaS instances coupling with the EBM servers, without other systems coupling with the EBM servers except with a server cleanup and monitoring system. Different from a monolithic model of a metal as a service (“MAAS”) service, such as Canonical, the MaaS instances as described herein comprise a distributed metal as a service system in which each edge site (e.g., each EBM server) has its own MaaS instance for coupling with the interface system that is described herein. Also, unlike MAAS, which delivers whole libraries, examples of the MaaS instances described herein deliver only pertinent information. In some examples, the interface system may perform structured query language (“SQL”) queries directly with a relational database manage system (e.g., PostgreSQL® database, or the like) instead of using a native MAAS API.

These and other aspects of the interface and abstraction system for EBM service are described in greater detail with respect to the figures.

The following detailed description illustrates a few exemplary embodiments in further detail to enable one of skill in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present invention may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

In an aspect, the technology relates to a method, including receiving, by an interface system, first input requesting interaction with one or more EBM servers among a plurality of EBM servers. The plurality of EBM servers is each located at a network edge and is each configured to provide bare metal server resources. The interface system provides a uniform interface between the plurality of EBM servers and one or more external systems (in some cases, a plurality of external systems). The method also includes establishing, by the interface system, a connection with each EBM server of the one or more EBM servers; and generating, by the interface system, one or more commands for each of the one or more EBM servers based on the first input, and sending, by the interface system, the one or more commands to each of the one or more EBM servers over the established connection with each EBM server. The one or more commands include at least one of one or more instructions or one or more queries. The method further includes accessing and abstracting, by the interface system, data from the one or more EBM servers via the established connection with each EBM server, generating, by the interface system, one or more data views based on the abstracted data, and presenting, by the interface system, the one or more data views to a requesting system among the one or more external systems.

In some embodiments, the one or more external systems each includes one of a bare metal controller (“BMC”), a server management system, a user interface (“UI”) system, a web portal, a dashboard software application (“app”), a server, or a user device, and/or the like. In some cases, the one or more external systems communicatively couple with the interface system via one or more networks.

According to some embodiments, establishing the connection with each EBM server of the one or more EBM servers includes establishing, by the interface system, a connection with each EBM server of the one or more EBM servers, using a metal as a service (“MaaS”) instance among a plurality of MaaS instances. In some instances, the plurality of MaaS instances may provide asynchronous application programming interface (“API”) functionality between the interface system and the one or more EBM servers. Alternatively, establishing the connection with each EBM server of the one or more EBM servers includes establishing, by the interface system, a connection with each EBM server of the one or more EBM servers, using one of a secure shell (“SSH”) protocol-based connection or a representational state transfer-based (“RESTful”) API.

In some embodiments, the method further includes, in response to receiving a query from the requesting system, searching, by the interface system, a cache or a local data store for answers to the query. The method further includes, based on a determination that the cache or the local data store contains answers to the query, sending, by the interface system, one or more first responses to the requesting system, based on the answers contained in the cache or the local data store. Alternatively, the method further includes, based on a determination that the cache or the local data store does not contain answers to the query, relaying, by the interface system, the query to the one or more EBM servers over the established connection with each EBM server, and, in response to receiving one or more second responses to the query from at least one EBM server, relaying, by the interface system, the one or more second responses to the requesting system. In examples, the one or more data views include one of the one or more first responses or the one or more second responses.

Merely by way of example, in some cases, at least one of the requested interaction or the one or more commands include at least one of enabling hyper-threading in an EBM server, disabling hyper-threading in the EBM server, formatting the EBM server, managing EBM infrastructure, tracking inventory of MaaS instances, monitoring states of MaaS instances, tracking access credentials, performing bare metal compute functionality, building a machine, rebooting a machine, listing servers, listing operating systems, obtaining statuses of MaaS sites, obtaining statuses of active MaaS sites, obtaining operating system (“OS”) images, querying MaaS, forwarding a query payload to a MaaS site and return results from the MaaS site, allocating a server in a specific MaaS site, obtaining machine inventory from a plurality of MaaS sites, deploying a server in MaaS site, releasing a server in MaaS site with a disk erase, updating site information, making changes across multiple MaaS sites with single change using the interface system, formatting drives, installing OSs, setting up user data views, installing packages, or starting network services, and/or the like.

According to some embodiments, the method further includes abstracting, by the interface system, access credentials for the one or more EBM servers; and, based on the abstracted access credentials, providing, by the interface system, at least one external system among the one or more external systems with access to the one or more EBM servers when the at least one external system provides access credentials to the interface system, where the at least one external system otherwise lacks access to the one or more EBM servers. In some instances, the interface system provides network connectivity between the at least one external system and the one or more EBM servers over the provided access to the one or more EBM servers, the network connectivity including secure connection.

In some examples, the interface system is implemented within at least one of one or more containers or one or more virtual machines (“VMs”) that are hosted on network nodes within an EBM management cluster located within the network edge. In examples, the method further includes performing, by the interface system, at least one of collating the data that is accessed and abstracted from the one or more EBM servers, caching the data, obfuscating the one or more EBM servers, handling errors, performing network self-healing, remediating network outages, remediating network failures, or remediating breaches, and/or the like.

In some embodiments, the method further includes composing, by the interface system, one or more composable infrastructure components virtually into one of the one or more EBM servers. In some cases, the one or more composable infrastructure components include one or more graphics processing units (“GPUs”). In some instances, composing the one or more composable infrastructure components includes composing, by the interface system, the one or more GPUs virtually into one of the one or more EBM servers using remote direct memory access (“RDMA”) over Ethernet.

According to some embodiments, the method further includes performing, by a server cleanup and monitoring system, server cleanup of an EBM server among the plurality of EBM servers that is no longer providing network services. In some examples, the server cleanup includes at least one of deleting service configurations on the EBM server, rewriting a basic input/output system (“BIOS”) of the EBM server with a replacement BIOS, updating the BIOS of the EBM server, loading a standard configuration on the EBM server, determining whether firmware files on the EBM server are up-to-date, or hardening an operating system of the EBM server to enhance security features of the EBM server, and/or the like.

In another aspect, the technology relates to a system, including a plurality of EBM servers and an interface system. In examples, the plurality of EBM servers is each located at a network edge and is each configured to provide bare metal server resources. The interface system may include at least one first processor and a first non-transitory computer readable medium communicatively coupled to the at least one first processor. The first non-transitory computer readable medium may have stored thereon computer software including a first set of instructions that, when executed by the at least one first processor, causes the interface system to: receive first input requesting interaction with one or more EBM servers among the plurality of EBM servers, wherein the interface system provides a uniform interface between the plurality of EBM servers and one or more external systems (in some cases, a plurality of external systems); establish a connection with each EBM server of the one or more EBM servers; generate one or more commands for each of the one or more EBM servers based on the first input, the one or more commands including at least one of one or more instructions or one or more queries; and send the one or more commands to each of the one or more EBM servers over the established connection with each EBM server.

In some embodiments, the first set of instructions, when executed by the at least one first processor, further causes the interface system to: access and abstract data from the one or more EBM servers via the established connection with each EBM server; generate one or more data views based on the abstracted data; and present the one or more data views to a requesting system among the one or more external systems.

According to some embodiments, the first set of instructions, when executed by the at least one first processor, further causes the interface system to, in response to receiving a query from the requesting system, search a cache or a local data store for answers to the query, and perform one of: (a) based on a determination that the cache or the local data store contains answers to the query, send one or more first responses to the requesting system, based on the answers contained in the cache or the local data store; or (b) based on a determination that the cache or the local data store does not contain answers to the query, relay the query to the one or more EBM servers over the established connection with each EBM server, and, in response to receiving one or more second responses to the query from at least one EBM server, relay the one or more second responses to the requesting system.

In yet another aspect, the technology relates to a method, including receiving, by an interface system, first input requesting interaction with one or more EBM servers among a plurality of EBM servers. The plurality of EBM servers is each located at a network edge and is each configured to provide bare metal server resources. The interface system provides a uniform interface between the plurality of EBM servers and one or more external systems (in some cases, a plurality of external systems). The method further includes establishing, by the interface system, a connection with each EBM server of the one or more EBM servers; and implementing, by the interface system, interaction between a requesting system among the one or more external systems and each EBM server over the established connection, by abstracting commands from the requesting system for sending to each EBM server and by abstracting data received from each EBM server for presenting to the requesting system.

In some embodiments, abstracting commands from the requesting system for sending to each EBM server includes generating, by the interface system, one or more commands for each of the one or more EBM servers based on the first input, the one or more commands including at least one of one or more instructions or one or more queries, and sending, by the interface system, the one or more commands to each of the one or more EBM servers over the established connection with each EBM server.

According to some embodiments, abstracting data received from each EBM server for presenting to the requesting system includes accessing and abstracting, by the interface system, data from the one or more EBM servers via the established connection with each EBM server, generating, by the interface system, one or more data views based on the abstracted data, and presenting, by the interface system, the one or more data views to a requesting system among the one or more external systems.

Various modifications and additions can be made to the embodiments discussed without departing from the scope of the invention. For example, while the embodiments described above refer to particular features, the scope of this invention also includes embodiments having different combination of features and embodiments that do not include all of the above-described features.

### Specific Exemplary Embodiments

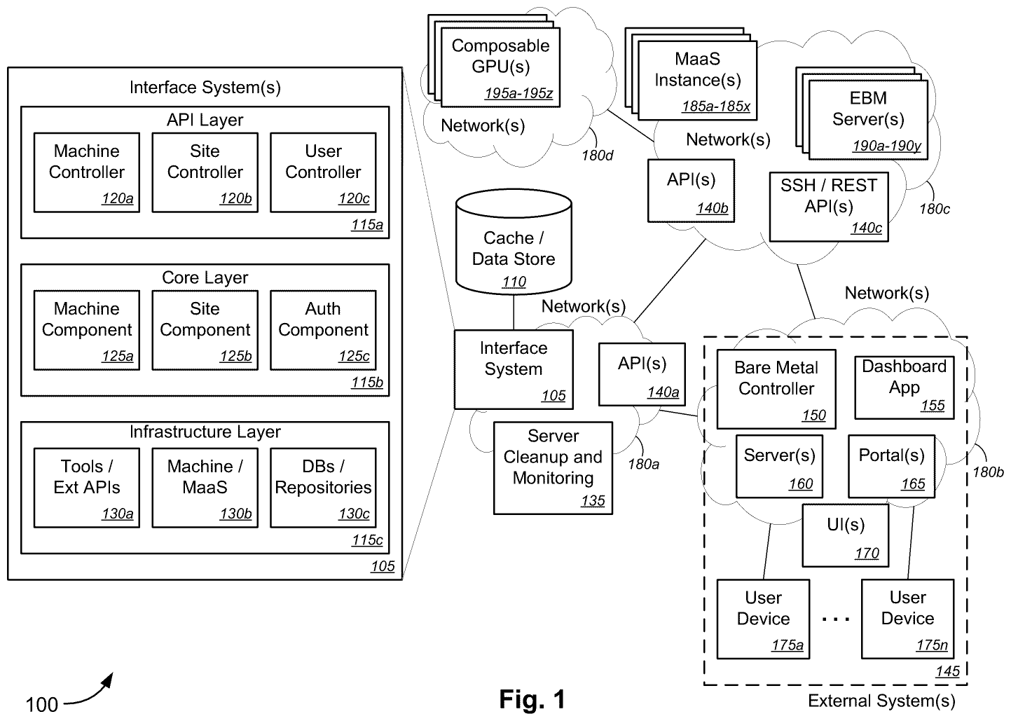

We now turn to the embodiments as illustrated by the drawings. FIGS. 1-5 illustrate some of the features of the method, system, and apparatus for implementing provisioning of network services, and, more particularly, to methods, systems, and apparatuses for implementing interface and abstraction system for edge bare metal (“EBM”) service, as referred to above. The methods, systems, and apparatuses illustrated by FIGS. 1-5 refer to examples of different embodiments that include various components and steps, which can be considered alternatives or which can be used in conjunction with one another in the various embodiments. The description of the illustrated methods, systems, and apparatuses shown in FIGS. 1-5 is provided for purposes of illustration and should not be considered to limit the scope of the different embodiments.

With reference to the figures, FIG. 1 depicts a schematic diagram illustrating a system 100 for implementing interface and abstraction system for EBM service, in accordance with various embodiments. In the non-limiting example of FIG. 1, system 100 includes interface system 105 and cache and/or data store 110. In examples, the interface system 105 includes application programming interface (“API”) layer 115a, core layer 115b, and infrastructure layer 115c. The interface system 105 provides a uniform interface (in some cases, a single uniform interface) between an inventory of EBM servers (e.g., EBM servers 190a-190y, or the like) and a plurality of external systems (e.g., external system(s) 145, or the like), and provides an API(s) for asynchronous interaction with an entirety of the inventory of the EBM servers. As part of the API layer 115a, interface system 105 includes machine controller 120a, site controller 120b, and user controller 120c, or the like. As part of the core layer 115b, interface system 105 includes machine component 125a, site component 125b, and authentication component 125c, or the like. As part of the infrastructure layer 115c, interface system 105 includes tools and/or external APIs 130a, machine and/or MaaS system 130b, and databases and/or repositories 130c. System 100 further includes server cleanup and monitoring system 135, one or more APIs 140a-140c, and one or more external systems 145, or the like. In some examples, the one or more external systems 145 includes at least one of bare metal controller (“BMC”) 150, dashboard software application (“app”) 155, one or more servers 160, one or more portals 165, one or more user interfaces (“UIs”), or one or more user devices 175a-175n (collectively, “user devices 175”), and/or the like. In some embodiments, interface system 105, cache and/or data store 110, server cleanup and monitoring system 135, APIs 140a-140c, and external systems 145 may be disposed in network(s) 180, which may include network(s) 180a-180d. In examples, some of these components of system 100 may be disposed or located in some portion of network(s) 180a-180d, while other components may be disposed or located in other portions of network(s) 180a-180d, as shown, e.g., in FIG. 1.

According to some embodiments, system 100 may further include one or more MaaS instances 185a-185x (collectively, “MaaS instances 185”) and EBM servers 190a-190y (collectively, “EBM servers 190”), which may both be disposed in one or more portions of network(s) 180a-180d, in some cases, at a network edge. As used herein, the network edge may refer to a portion of the network(s) 180 where a device or local network interfaces with the Internet and/or with third party networks. In some cases, the network edge is located close to devices it is communicating with and is the entry or exit point to the network(s) 180. In some embodiments, system 100 may further include one or more composable GPUs 195a-195z (collectively, “composable GPUs 195” or “GPUs 195”), which may also be disposed in a portion of network(s) 180 (e.g., in network(s) 180d, as shown in FIG. 1, or the like). Herein, n, x, y, and z are non-negative integer numbers that may be either all the same as each other, all different from each other, or some combination of same and different (e.g., one set of two or more having the same values with the others having different values, a plurality of sets of two or more having the same value with the others having different values, etc.).

Operations and interactions with the inventory of the EBM servers 190 are handled through the interface system 105. In an example, the interface system 105 handles any and all operations and interactions with the inventory of the EBM servers 190. In some examples, the interface system makes direct calls to MaaS instances coupling with the EBM servers, without other systems coupling with the EBM servers except with a server cleanup and monitoring system. In this manner, external systems that need to interact with the inventory of the EBM servers are provided with a consistent endpoint regardless of how many, or even what type, of bare metal inventory and management systems are in use across the network or the network edge. Once an EBM server 190 is no longer in use by one user (e.g., after the EBM server 190 has been released, etc.) and prior to use by another user (or subsequent re-use by the same user), server cleanup and monitoring system 135 is used to perform server cleanup, including at least one of deleting service configurations on the EBM server, rewriting a basic input/output system (“BIOS”) of the EBM server with a replacement BIOS, updating the BIOS of the EBM server, loading a standard configuration on the EBM server, determining whether firmware files on the EBM server are up-to-date, or hardening an operating system of the EBM server to enhance security features of the EBM server, and/or the like.

Different from a monolithic model MAAS service, such as Canonical, the plurality of MaaS instances 185 is a distributed metal as a service system in which each edge site (e.g., each EBM server 190) has its own MaaS instance for coupling with the interface system 105 that is described herein. In some examples, MaaS instances and EBM management clusters connect to virtual routing and forwarding (“VRF”) directly in each edge site. BMC 150 is configured to serve as an orchestrator for the EBM servers 190 and for EBM services provided by the EBM servers 190, with which upstream systems are intended to interact. In examples, BMC 150 connects to a cloud computing platform (e.g., Microsoft Azure®, or the like), which may connect back to the VRF via a logical connection between on-premises infrastructure and the cloud services as well as various internal management networks, or the like. Interface system 105 is further configured to obfuscate multiple MaaS instances by presenting a single interface to BMC 150 and/or other external systems 145.

In some examples, the interface system is implemented within at least one of one or more containers or one or more virtual machines (“VMs”) that are hosted on network nodes within an EBM management cluster (not shown) located within the network edge. In examples, interface system 105 is deployed behind a reverse-proxy where a container can be replaced without service interruptions. A container, as used herein, refers to a logical packaging in which software applications can be abstracted from the environment in which they are actually run or executed, by holding all the components (e.g., files, libraries, and environment variables) necessary for running or executing the software applications. A VM, as used herein, refers to a virtual computer system that emulates the functionality of a physical computer. In examples, each computing system 105 is a machine where containers or VMs are hosted or deployed, where the machine is either a physical computing system or a virtual computing system, and contains the associated components (e.g., container engine, host operating system, and infrastructure for machines hosting containers; or hypervisor and infrastructure for machines hosting VMs; etc.). In some examples, a container orchestration system (e.g., Docker Swarm® or Kubernetes®, etc.) may be set up to manage containers, while a load balancer may be used to provide failover redundancy and to provide scale.

In some aspects, composable infrastructure may be used for enhancing EBM services or functionalities. In examples, interface system 105 may compose one or more composable infrastructure components (e.g., composable GPUs 195a-195z, or the like) virtually into one or more of the EBM servers 190a-190y, in some cases, using remote direct memory access (“RDMA”) over Ethernet.

In some instances, the one or more user devices 175a-175n may each include, but is not limited to, one of a desktop computer, a laptop computer, a tablet computer, a smart phone, a mobile phone, a network operations center (“NOC”) computing system or console, or any suitable device capable of communicating with network(s) 180 or with servers or other network devices (e.g., other ones of the one or more external systems 145, or the like) within network(s) 180, or via any suitable device capable of communicating with at least one of the interface system 105, the server cleanup and monitoring system 135, and/or the BMC 150, and/or the like, via an API (e.g., API(s) 140a, or the like), an app (e.g., dashboard app 155, or the like), a server (e.g., server(s) 160, or the like), a web-based portal (e.g., portal(s) 165, or the like), a UI (e.g., UI(s) 170, or the like), or any other suitable communications interface, or the like (not shown), over network(s) 180. In some cases, the one or more user devices 175a-175n may be associated with corresponding customers/users (not shown in FIG. 1), which may each include, without limitation, one of an individual, a group of individuals, a private company, a group of private companies, a public company, a group of public companies, an institution, a group of institutions, an association, a group of associations, a governmental agency, a group of governmental agencies, or any suitable entity or their agent(s), representative(s), owner(s), and/or stakeholder(s), or the like.

According to some embodiments, network(s) 180 may each include, without limitation, one of a local area network (“LAN”), including, without limitation, a fiber network, an Ethernet network, a Token-Ring™ network, and/or the like; a wide-area network (“WAN”); a wireless wide area network (“WWAN”); a virtual network, such as a virtual private network (“VPN”); the Internet; an intranet; an extranet; a public switched telephone network (“PSTN”); an infra-red network; a wireless network, including, without limitation, a network operating under any of the IEEE 802.11 suite of protocols, the Bluetooth™ protocol known in the art, and/or any other wireless protocol; and/or any combination of these and/or other networks. In a particular embodiment, the network(s) 180 may include an access network of the service provider (e.g., an Internet service provider (“ISP”)). In another embodiment, the network(s) 180 may include a core network of the service provider and/or the Internet.

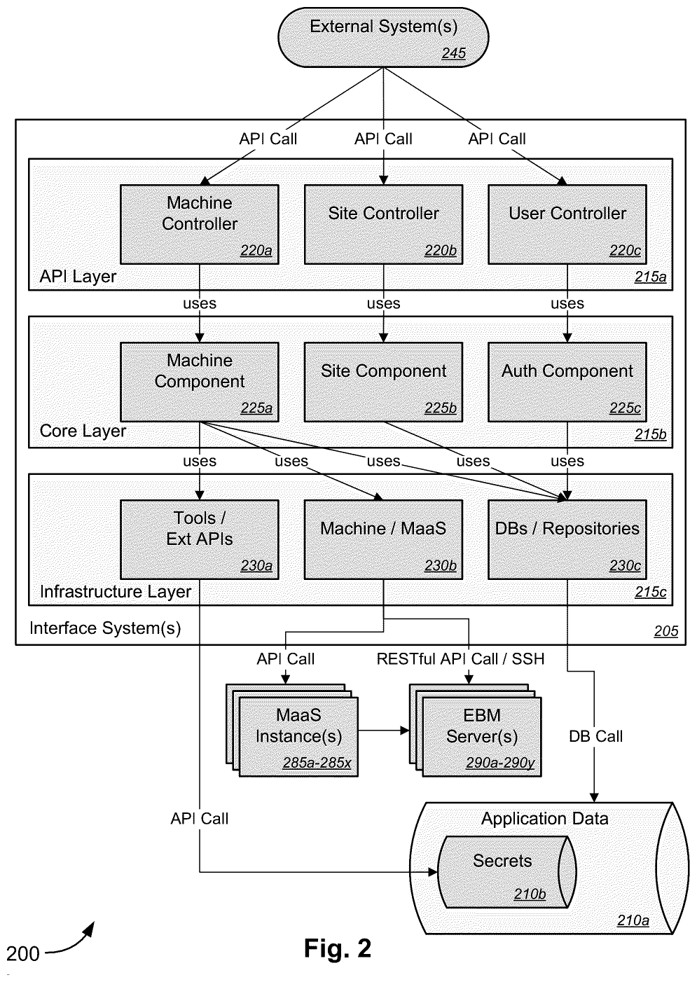

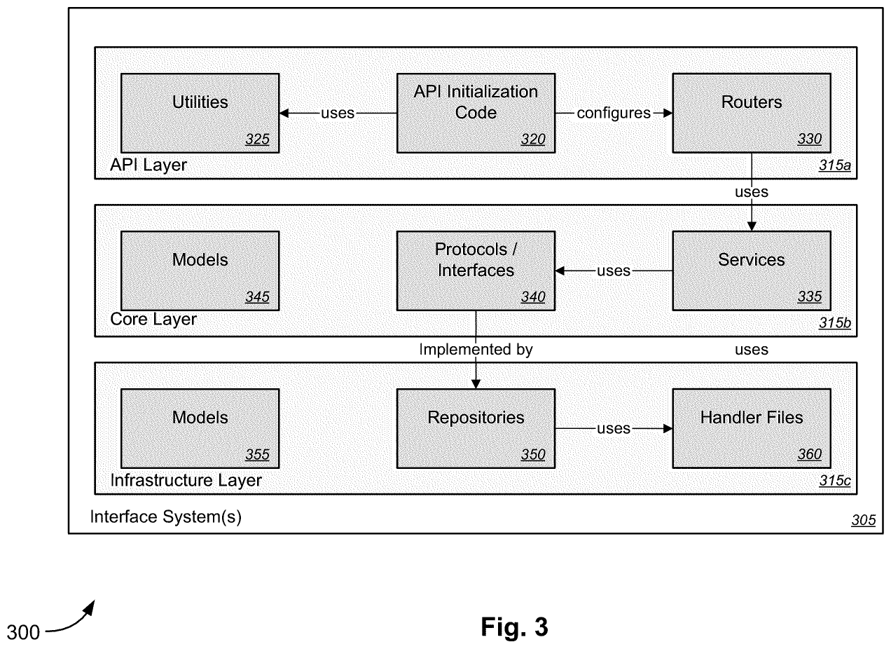

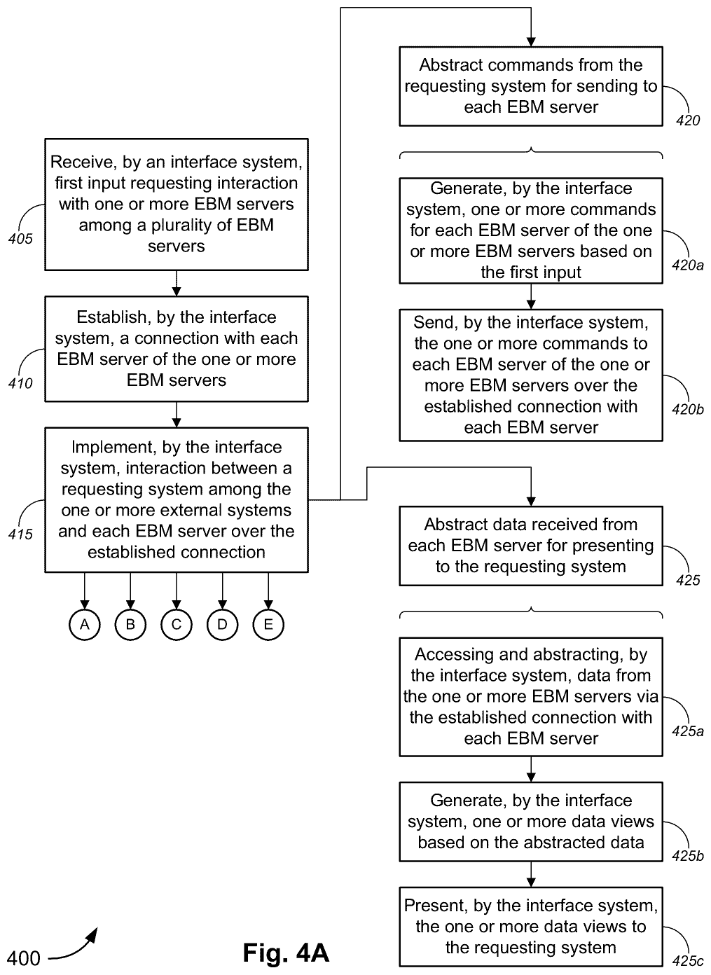

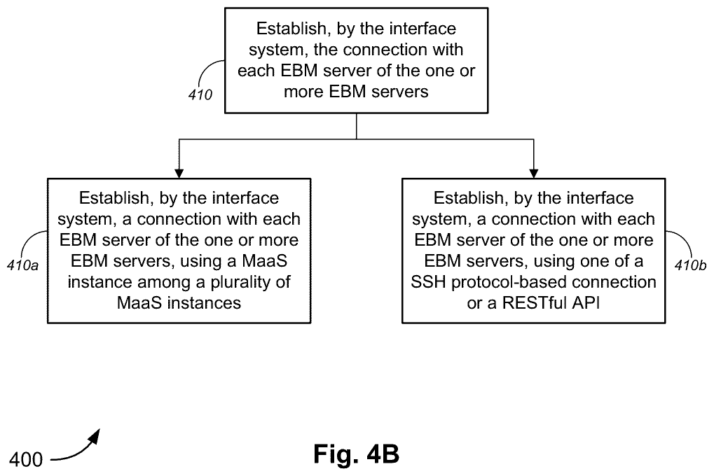

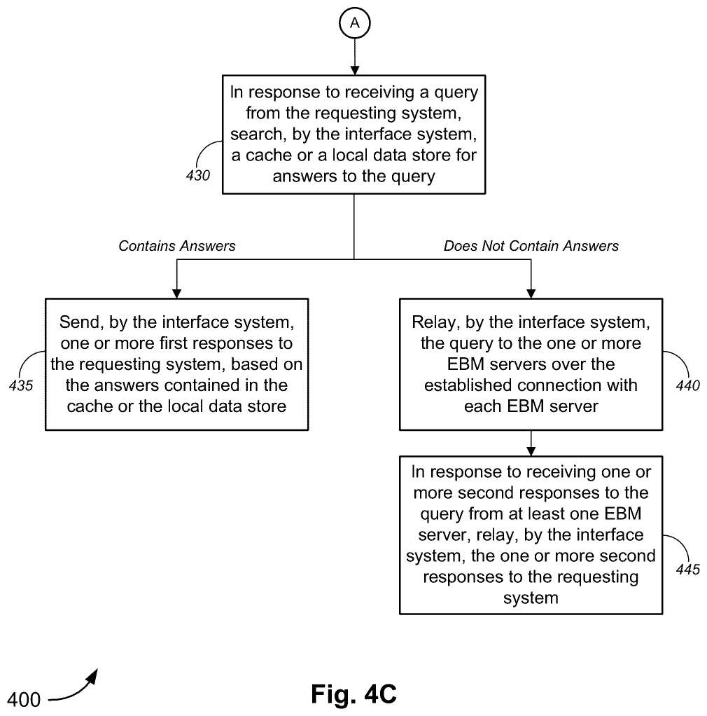

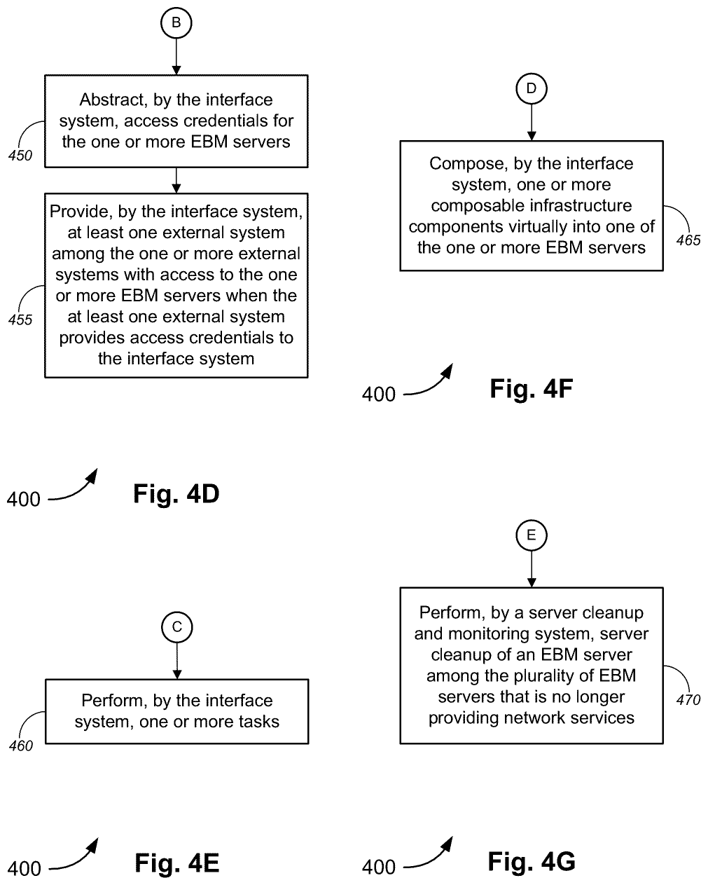

In operation, interface system 105, the server cleanup monitoring system 135, the BMC 150 and/or other external systems 145, the MaaS instances 185, and/or the EBM servers 190 (collectively, “computing system”) may perform methods for implementing interface and abstraction system for EBM service, as described in detail with respect to FIGS. 2-4. For example, FIG. 2 is directed to an example architecture 200 for implementing interface and abstraction system for EBM service, while FIG. 3 is directed to an example code workflow 300 for implementing the interface and abstraction system for EBM service. FIGS. 4A-4G are directed to a method 400 for implementing the interface and abstraction system for EBM service.

FIG. 2 depicts a schematic diagram illustrating a non-limiting example architecture 200 for implementing interface and abstraction system for EBM service, in accordance with various embodiments. In some embodiments, interface system 205, data stores containing application data 210a and secret data 210b, API layer 215a, machine controller 220a, site controller 220b, user controller 220c, core layer 215b, machine component 225a, site component 225b, authentication component 225c, infrastructure layer 215c, tools and/or external APIs 230a, machine and/or MaaS 230b, databases and/or repositories 230c, external system(s) 245, MaaS instances 285a-285x, and EBM servers 290a-290y of FIG. 2 may be similar, if not identical, to the interface system 105, cache and/or data store 110, API layer 115a, machine controller 120a, site controller 120b, user controller 120c, core layer 115b, machine component 125a, site component 125b, authentication component 125c, infrastructure layer 115c, tools and/or external APIs 130a, machine and/or MaaS 130b, databases and/or repositories 130c, external system(s) 145, MaaS instances 185a-185x, and EBM servers 190a-190y, respectively, of system 100 of FIG. 1, and the description of these components of system 100 of FIG. 1 are similarly applicable to the corresponding components of FIG. 2.

In examples, the API layer 215a handles API framework configuration and associated routes or routing, while the core layer 215b handles business logic for implementing core services of the interface system and defines interface or protocols that the core service uses to connect to other external systems controlled by the infrastructure layer 215c (e.g., systems other than external systems 245), and the infrastructure layer 215c implements the interface or protocols defined by the core layer 215b for handling connectivity with the other external systems (e.g., databases, APIs, and/or servers, etc.). In examples, the architecture 200 represents a hexagonal architecture that utilizes port and adapter architecture that separates core business logic from systems (e.g., databases, web frameworks, message queues, etc.) that are external to the architecture, in this cases interface system 205. The ports include APIs and interfaces that the interface system (or its application) defines communicate with external systems 245 and with the other external systems (e.g., EBM servers 290, databases, etc.), while the adapters are components that use the ports to interact with the external systems 245 and with the other external systems.

With reference to the non-limiting example architecture 200 of FIG. 2, an external system(s) 245—including at least one of a BMC (e.g., BMC 150 of FIG. 1, or the like), a dashboard app (e.g., dashboard app 155 of FIG. 1, or the like), one or more servers (e.g., servers 160 of FIG. 1, or the like), one or more portals (e.g., portals 165 of FIG. 1, or the like), one or more UIs (e.g., UIs 170 of FIG. 1, or the like), or one or more user devices (e.g., user devices 175a-175n of FIG. 1, or the like), and/or the like—may initiate an API call (in some cases, via API(s) 140a of FIG. 1, or the like) to one or more controllers 220 in the API layer 215a of interface system 205. In examples, the API call may include a REST API, and may use JavaScript® object notation (“JSON”) as a format for sending and receiving data over the REST API. In some cases, hypertext transfer protocol secure (“HTTPS”) may also be used for the API call. In some examples, the one or more controllers 220 may include machine controller 220a, site controller 220b, and/or user controller 220c, and/or the like. In this manner, the external system(s) 245 may send input requesting interaction with one or more EBM servers 290a-290y over an API call(s) to each of at least one of the machine controller 220a, the site controller 220b, and/or the user controller 220c, and/or the like, of the interface system 205. In some instances, each controller 220 may utilize FastAPI, which is a framework for building RESTful APIs, which supports asynchronous programming, and which provides for ease of use, speed, and robustness. According to some embodiments, FastAPI enables auto-generation of a UI (e.g., Swagger API® page or Swagger API® UI, etc., which is an interactive UI that is generated based on API structure that is defined by the interface system) and corresponding libraries for the API, the auto-generated UI being accessible as a route for the interface system 205 to interact with other APIs and/or external systems (e.g., external systems 245 and other external systems).

In some examples, machine controller 220a in the API layer 215a of interface system 205 is configured to utilize the framework for building RESTful APIs (e.g., FastAPI, or the like) with external system(s) 245 and uses machine component 225a in the core layer 215b to connect with caches/data stores (e.g., cache and/or data store 110 of FIG. 1, or the like) and/or with EBM servers (e.g., EBM servers 290a-290y, or the like). Machine component 225a uses infrastructure components in the infrastructure layer 215c to connect with the caches/data stores and/or with the EBM servers, via APIs (in some cases, via MaaS instances 285a-285x, or the like) or other connection. In some cases, machine controller 220a uses machine component 225a to utilize tools or external APIs 230a to access secrets or secret data 210b in caches/data stores (e.g., cache and/or data store 110 of FIG. 1, or the like). In some instances, machine controller 220a uses machine component 225a to utilize machine or MaaS system 230b to communicatively couple with EBM servers 290a-290y. In an example, machine or MaaS system 230b sends an API call to one of MaaS instance(s) 285a-285x (in some cases, via API(s) 140b of FIG. 1, or the like), the MaaS instance 285 connecting with a corresponding one of the EBM servers 290. In another example, machine or MaaS system 230b connects with one of the EBM servers 290 via SSH or REST APIs (e.g., SSH or REST APIs 140c of FIG. 1, or the like). In some examples, machine controller 220a uses machine component 225a that uses databases or repositories 230c in the infrastructure layer 215c to access some application data 210a (e.g., machine cache, etc.) in caches/data stores (e.g., cache and/or data store 110 of FIG. 1, or the like). Site controller 220b is configured to utilize the framework for building RESTful APIs (e.g., FastAPI, or the like) with external system(s) 245 and uses site component 225b in the core layer 215b that uses databases or repositories 230c in the infrastructure layer 215c to access some application data (e.g., site information, etc.) in caches/data stores (e.g., cache and/or data store 110, or the like). User controller 220c is configured to utilize the framework for building RESTful APIs (e.g., FastAPI, or the like) with external system(s) 245 and uses authentication component 225c in the core layer 215b that uses databases or repositories 230c in the infrastructure layer 215c to access some application data (e.g., basic authentication data, etc.) in caches/data stores (e.g., cache and/or data store 110, or the like).

In an aspect, interface system 205 receives first input requesting interaction with one or more EBM servers 290 among the plurality of EBM servers 290a-290y. The interface system 205 establishes a connection with each EBM server 290 (e.g., in a manner as described in detail above, or the like), and generates one or more commands for each of the one or more EBM servers 290 based on the first input. In some examples, the one or more commands include at least one of one or more instructions or one or more queries. The interface system 205 sends the one or more commands to each of the one or more EBM servers 290 over the established connection with each EBM server 290 (e.g., via MaaS instance 285 or via REST APIs or SSH, or the like, as described above). In some examples, the interface system 205 accesses and abstracts data from the one or more EBM servers 290 via the established connection with each EBM server 290, generates one or more data views based on the abstracted data, and presents the one or more data views to a requesting system among the one or more external systems 245.

In some embodiments, interface system 205, in response to receiving a query from the requesting system, may search a cache or a local data store (e.g., cache and/or data store 110 of FIG. 1, or the like) for answers to the query. Based on a determination that the cache or the local data store contains answers to the query, interface system 205 may send one or more first responses to the requesting system, based on the answers contained in the cache or the local data store. Based on a determination that the cache or the local data store does not contain answers to the query, however, interface system 205 may relay the query to the one or more EBM servers 290 over the established connection with each EBM server, and, in response to receiving one or more second responses to the query from at least one EBM server 290, may relay the one or more second responses to the requesting system. In examples, the one or more data views include one of the one or more first responses or the one or more second responses.

Merely by way of example, in some cases, at least one of the requested interaction or the one or more commands include at least one of enabling hyper-threading in an EBM server, disabling hyper-threading in the EBM server, formatting the EBM server, managing EBM infrastructure, tracking inventory of MaaS instances, monitoring states of MaaS instances, tracking access credentials, performing bare metal compute functionality, building a machine, rebooting a machine, listing servers, listing operating systems, obtaining statuses of MaaS sites, obtaining statuses of active MaaS sites, obtaining operating system (“OS”) images, querying MaaS, forwarding a query payload to a MaaS site and return results from the MaaS site, allocating a server in a specific MaaS site, obtaining machine inventory from a plurality of MaaS sites, deploying a server in MaaS site, releasing a server in MaaS site with a disk erase, updating site information, making changes across multiple MaaS sites with single change using the interface system, formatting drives, installing OSs, setting up user data views, installing packages, or starting network services, and/or the like. In examples, in querying MaaS, the interface system passes a query payload to a given site and returns the results from MaaS. If a site parameter is not provided, the interface system passes the query to all active sites. If an active parameter is provided, the interface system will target MaaS instances associated with active sites.

In some aspects, where at least one external system 245 otherwise lacks access to the one or more EBM servers 290a-290y, interface system 205 serves as a single, uniform interface with the one or more EBM servers (or the plurality of EBM servers) 290a-290y for the at least one external system 245, by abstracting access credentials for the one or more EBM servers 290a-290y. Based on the abstracted access credentials, the interface system 205 provides the at least one external system 245 with access to the one or more EBM servers 290a-290y. In some instances, the interface system 290 provides also network connectivity between the at least one external system 245 and the one or more EBM servers 290a-290y over the provided access to the one or more EBM servers, the network connectivity including secure connection.

In another aspect, interface system 205 may perform at least one of collating data that is accessed and abstracted from the one or more EBM servers 290a-290y, caching the data (e.g., in cache and/or data store 110 of FIG. 1, or the like), obfuscating the one or more EBM servers 290a-290y (e.g., from the perspective of the external system(s) 245), and/or performing network self-healing, and/or the like. In examples, performing network self-healing may include at least one of handling errors (e.g., network errors, errors with connecting to the cache or data store 110, to the EBM servers 290 and/or to the external system(s) 245, etc.), remediating network outages (e.g., network outages associated with connecting with the cache or data store 110, the EBM servers 290 and/or the external system(s) 245, etc.), remediating network failures (e.g., network failures associated with connecting with the cache or data store 110, the EBM servers 290 and/or the external system(s) 245, etc.), or remediating breaches (e.g., security breaches through interface system 205 itself or its APIs, etc.), and/or the like. In some examples, errors that may be encountered (and subsequently handled) may include one or more of an error that is raised when provided query parameters for a given call cannot identify an appropriate MaaS instance to query, an error that is raised when an API call is made with incorrect or missing credentials, an error that is raised when a user provides valid credentials but is not authorized to perform the action attempted (which may occur with experimental features, or the like), an error that is raised when the interface system cannot successfully aggregate a multi-MaaS call result or fails in an otherwise intentional way while attempting to do so, an error that is raised when the interface system cannot query or update site entries in a cache or data store, an error that is raised when a user has provided an invalid input for identifying a site (e.g., “site=MMMM, where MMMM is invalid, or the like), an error that is raised when a MaaS instance the interface system is attempting to query cannot be found (such as when the associated MaaS entry in the cache or data store has incorrect settings (e.g., incorrect region_ip settings, or the like), and/or an error that is raised when data is malformed, missing, or cannot be decoded from MaaS, and/or the like.

In an aspect, when the interface system has to be updated or replaced, a stand-by interface system is used. In an example, the existing container for the interface system is removed and replaced with a replacement container based on a latest image from a public instance of the interface system. The configuration for a web server (e.g., NGINX®, or the like) is updated to point to the replacement container (where the updates would apply after the next web server service reload or restart). The web server is reloaded in the container, allowing existing API commands to finish from the previously existing container while routing new connections to the replacement container. Deployment configuration is updated with the latest state.

These and other functions of the example 200 (and its components) are described in greater detail herein with respect to FIGS. 1, 3, and 4.

FIG. 3 depicts a block flow diagram illustrating a non-limiting example code workflow 300 for implementing interface and abstraction system for EBM service, in accordance with various embodiments. In some embodiments, interface system 305, API layer 315a, core layer 315b, and infrastructure layer 315c of FIG. 3 may be similar, if not identical, to the interface system 105, API layer 115a, core layer 115b, and infrastructure layer 115c, respectively, of system 100 of FIG. 1, and the description of these components of system 100 of FIG. 1 are similarly applicable to the corresponding components of FIG. 2.

With reference to the non-limiting example code workflow 300 of FIG. 3, in API layer 315a of interface system 305, API initialization code 320 uses utilities 325 (e.g., framework and API-centric helper tools, or the like) to configure routers 330, to configure an API framework, and to define API routes (e.g., API routes to routers 330, or the like, in some cases, based on the configured API framework, or the like), or the like. Routers 330 use services 335 in core layer 315b of interface system 305, the services 335 providing core business logic, or the like. In some examples, the core business logic is represented as services 335. The core layer 315b uses models 345 for keeping data structured and predictable, in some cases, using a code library for data parsing and validation and/or using data classes, or the like. Services 335 use protocols and/or interfaces 340 for defining how the service leverages infrastructure. Repositories 350 in the infrastructure layer 315c of interface system 305 implement the protocols and/or interfaces 340, and use handler files 360 to implement external tooling interactions with other external systems (e.g., databases, configuration files, other services APIs, etc.) using objects or other external services handlers, or the like. The infrastructure layer 315c uses models 355 (e.g., in a manner similar to core layer 315b using models 345) for keeping data structured and predictable, in some cases, using a code library for data parsing and validation and/or using data classes, or the like.

These and other functions of the example 300 (and its components) are described in greater detail herein with respect to FIGS. 1, 2, and 4.

FIGS. 4A-4G (collectively, “FIG. 4”) depicts flow diagrams illustrating a method 400 for implementing interface and abstraction system for EBM service, in accordance with various embodiments. Method 400 of FIG. 4A continues onto FIG. 4C following the circular marker denoted, “A,” continues onto FIG. 4D following the circular marker denoted, “B,” continues onto FIG. 4E following the circular marker denoted, “C,” continues onto FIG. 4F following the circular marker denoted, “D,” and/or continues onto FIG. 4G following the circular marker denoted, “E.”

While the techniques and procedures are depicted and/or described in a certain order for purposes of illustration, it should be appreciated that certain procedures may be reordered and/or omitted within the scope of various embodiments. Moreover, while the method 400 illustrated by FIG. 4 can be implemented by or with (and, in some cases, are described below with respect to) the systems, examples, or embodiments 100, 200, and 300 of FIGS. 1, 2, and 3, respectively (or components thereof), such methods may also be implemented using any suitable hardware (or software) implementation. Similarly, while each of the systems, examples, or embodiments 100, 200, and 300 of FIGS. 1, 2, and 3, respectively (or components thereof), can operate according to the method 400 illustrated by FIG. 4 (e.g., by executing instructions embodied on a computer readable medium), the systems, examples, or embodiments 100, 200, and 300 of FIGS. 1, 2, and 3 can each also operate according to other modes of operation and/or perform other suitable procedures.

In the non-limiting embodiment of FIG. 4A, method 400, at operation 405, may include receiving, by an interface system, first input requesting interaction with one or more EBM servers among a plurality of EBM servers. The plurality of EBM servers is each located at a network edge and is each configured to provide bare metal server resources, as described in detail above. The interface system provides a uniform interface between the plurality of EBM servers and one or more external systems (in some cases, a plurality of external systems). In some embodiments, the one or more external systems each includes one of a bare metal controller (“BMC”), a server management system, a user interface (“UI”) system, a web portal, a dashboard software application (“app”), a server, or a user device, and/or the like. In some cases, the one or more external systems communicatively couple with the interface system via one or more networks.

At operation 410, method 400 may include establishing, by the interface system, a connection with each EBM server of the one or more EBM servers. At operation 415, method 400 may further include implementing, by the interface system, interaction between a requesting system among the one or more external systems and each EBM server over the established connection, by abstracting commands from the requesting system for sending to each EBM server (at operation 420) and by abstracting data received from each EBM server for presenting to the requesting system (at operation 425).

In some embodiments, abstracting commands from the requesting system for sending to each EBM server (at operation 420) includes generating, by the interface system, one or more commands for each of the one or more EBM servers based on the first input (at operation 420a), the one or more commands including at least one of one or more instructions or one or more queries, and sending, by the interface system, the one or more commands to each of the one or more EBM servers over the established connection with each EBM server (at operation 420b).

According to some embodiments, abstracting data received from each EBM server for presenting to the requesting system (at operation 425) includes accessing and abstracting, by the interface system, data from the one or more EBM servers via the established connection with each EBM server (at operation 425a), generating, by the interface system, one or more data views based on the abstracted data (at operation 425b), and presenting, by the interface system, the one or more data views to a requesting system among the one or more external systems (at operation 425c).

Merely by way of example, in some cases, at least one of the requested interaction or the one or more commands include at least one of enabling hyper-threading in an EBM server, disabling hyper-threading in the EBM server, formatting the EBM server, managing EBM infrastructure, tracking inventory of MaaS instances, monitoring states of MaaS instances, tracking access credentials, performing bare metal compute functionality, building a machine, rebooting a machine, listing servers, listing operating systems, obtaining statuses of MaaS sites, obtaining statuses of active MaaS sites, obtaining operating system (“OS”) images, querying MaaS, forwarding a query payload to a MaaS site and return results from the MaaS site, allocating a server in a specific MaaS site, obtaining machine inventory from a plurality of MaaS sites, deploying a server in MaaS site, releasing a server in MaaS site with a disk erase, updating site information, making changes across multiple MaaS sites with single change using the interface system, formatting drives, installing OSs, setting up user data views, installing packages, or starting network services, and/or the like. In some examples, the interface system is implemented within at least one of one or more containers or one or more virtual machines (“VMs”) that are hosted on network nodes within an EBM management cluster located within the network edge.

In some examples, method 400 may continue from the process at operation 415 onto at least one of the process at operation 430 in FIG. 4C following the circular marker denoted, “A,” the process at operation 450 in FIG. 4D following the circular marker denoted, “B,” the process at operation 460 in FIG. 4E following the circular marker denoted, “C,” the process at operation 465 in FIG. 4F following the circular marker denoted, “D,” and/or the process at operation 470 in FIG. 4G following the circular marker denoted, “E.”

Referring to FIG. 4B, establishing the connection with each EBM server of the one or more EBM servers (at operation 410) includes establishing, by the interface system, a connection with each EBM server of the one or more EBM servers, using a MaaS instance among a plurality of MaaS instances (at operation 410a). In some instances, the plurality of MaaS instances may provide asynchronous API functionality between the interface system and the one or more EBM servers. Alternatively, establishing the connection with each EBM server of the one or more EBM servers (at operation 410) includes establishing, by the interface system, a connection with each EBM server of the one or more EBM servers, using one of a SSH protocol-based connection or a RESTful API (at operation 410b).

At operation 430 in FIG. 4C (following the circular marker denoted, “A,” in FIG. 4A), method 400 may include, in response to receiving a query from the requesting system, searching, by the interface system, a cache or a local data store for answers to the query. The method further includes, based on a determination that the cache or the local data store contains answers to the query, sending, by the interface system, one or more first responses to the requesting system, based on the answers contained in the cache or the local data store (at operation 435). Alternatively, the method further includes, based on a determination that the cache or the local data store does not contain answers to the query, relaying, by the interface system, the query to the one or more EBM servers over the established connection with each EBM server (at operation 440), and, in response to receiving one or more second responses to the query from at least one EBM server, relaying, by the interface system, the one or more second responses to the requesting system (at operation 445). In examples, the one or more data views include one of the one or more first responses or the one or more second responses.

At operation 450 in FIG. 4D (following the circular marker denoted, “B,” in FIG. 4A), method 400 may include abstracting, by the interface system, access credentials for the one or more EBM servers. Method 400 may further include, at operation 455, based on the abstracted access credentials, providing, by the interface system, at least one external system among the one or more external systems with access to the one or more EBM servers when the at least one external system provides access credentials to the interface system, where the at least one external system otherwise lacks access to the one or more EBM servers. In some instances, the interface system provides network connectivity between the at least one external system and the one or more EBM servers over the provided access to the one or more EBM servers, the network connectivity including secure connection.

At operation 460 in FIG. 4E (following the circular marker denoted, “C,” in FIG. 4A), method 400 may include performing, by the interface system, one or more tasks. In examples, the one or more tasks may include at least one of collating the data that is accessed and abstracted from the one or more EBM servers, caching the data, obfuscating the one or more EBM servers, handling errors, performing network self-healing, remediating network outages, remediating network failures, or remediating breaches, and/or the like.

At operation 465 in FIG. 4F (following the circular marker denoted, “D,” in FIG. 4A), method 400 may include composing, by the interface system, one or more composable infrastructure components virtually into one of the one or more EBM servers. In some examples, the one or more composable infrastructure components include one or more GPUs. In some instances, composing the one or more composable infrastructure components includes composing, by the interface system, the one or more GPUs virtually into one of the one or more EBM servers using RDMA over Ethernet.

At operation 470 in FIG. 4G (following the circular marker denoted, “E,” in FIG. 4A), method 400 may include performing, by a server cleanup and monitoring system, server cleanup of an EBM server among the plurality of EBM servers that is no longer providing network services. In some examples, the server cleanup includes at least one of deleting service configurations on the EBM server, rewriting a basic input/output system (“BIOS”) of the EBM server with a replacement BIOS, updating the BIOS of the EBM server, loading a standard configuration on the EBM server, determining whether firmware files on the EBM server are up-to-date, or hardening an operating system of the EBM server to enhance security features of the EBM server, and/or the like.

### Exemplary System and Hardware Implementation

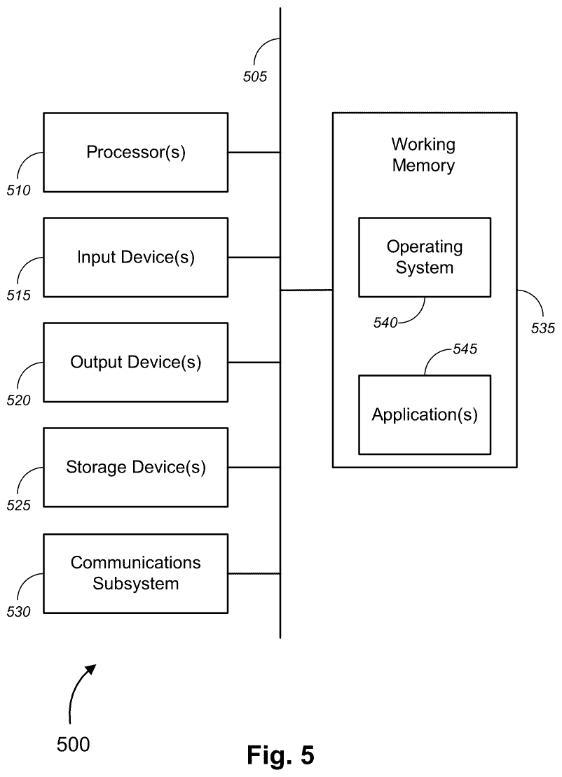

FIG. 5 is a block diagram illustrating an exemplary computer or system hardware architecture, in accordance with various embodiments. FIG. 5 provides a schematic illustration of one embodiment of a computer system 500 of the service provider system hardware that can perform the methods provided by various other embodiments, as described herein, and/or can perform the functions of computer or hardware system (i.e., interface systems 105, 205, and 305, server cleanup and monitoring system 135, external systems 145 and 245, BMC 150, server(s) 160, user devices 175a-175n, EBM servers 190a-190y and 290a-290y and composable GPUs 195a-195z, etc.), as described above. It should be noted that FIG. 5 is meant only to provide a generalized illustration of various components, of which one or more (or none) of each may be utilized as appropriate. FIG. 5, therefore, broadly illustrates how individual system elements may be implemented in a relatively separated or relatively more integrated manner.

The computer or hardware system 500—which might represent an embodiment of the computer or hardware system (i.e., interface systems 105, 205, and 305, server cleanup and monitoring system 135, external systems 145 and 245, BMC 150, server(s) 160, user devices 175a-175n, EBM servers 190a-190y and 290a-290y and composable GPUs 195a-195z, etc.), described above with respect to FIGS. 1-4—is shown including hardware elements that can be electrically coupled via a bus 505 (or may otherwise be in communication, as appropriate). The hardware elements may include one or more processors 510, including, without limitation, one or more general-purpose processors and/or one or more special-purpose processors (such as microprocessors, digital signal processing chips, graphics acceleration processors, and/or the like); one or more input devices 515, which can include, without limitation, a mouse, a keyboard, and/or the like; and one or more output devices 520, which can include, without limitation, a display device, a printer, and/or the like.

The computer or hardware system 500 may further include (and/or be in communication with) one or more storage devices 525, which can include, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable, and/or the like. Such storage devices may be configured to implement any appropriate data stores, including, without limitation, various file systems, database structures, and/or the like.

The computer or hardware system 500 might also include a communications subsystem 530, which can include, without limitation, a modem, a network card (wireless or wired), an infra-red communication device, a wireless communication device and/or chipset (such as a Bluetooth™ device, an 802.11 device, a Wi-Fi device, a WiMAX device, a wireless wide area network (“WWAN”) device, cellular communication facilities, etc.), and/or the like. The communications subsystem 530 may permit data to be exchanged with a network (such as the network described below, to name one example), with other computer or hardware systems, and/or with any other devices described herein. In many embodiments, the computer or hardware system 500 will further include a working memory 535, which can include a RAM or ROM device, as described above.

The computer or hardware system 500 also may include software elements, shown as being currently located within the working memory 535, including an operating system 540, device drivers, executable libraries, and/or other code, such as one or more application programs 545, which may include computer programs provided by various embodiments (including, without limitation, hypervisors, virtual machines (“VMs”), and the like), and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be encoded and/or stored on a non-transitory computer readable storage medium, such as the storage device(s) 525 described above. In some cases, the storage medium might be incorporated within a computer system, such as the system 500. In other embodiments, the storage medium might be separate from a computer system (i.e., a removable medium, such as a compact disc, etc.), and/or provided in an installation package, such that the storage medium can be used to program, configure, and/or adapt a general purpose computer with the instructions/code stored thereon. These instructions might take the form of executable code, which is executable by the computer or hardware system 500 and/or might take the form of source and/or installable code, which, upon compilation and/or installation on the computer or hardware system 500 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware (such as programmable logic controllers, field-programmable gate arrays, application-specific integrated circuits, and/or the like) might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer or hardware system (such as the computer or hardware system 500) to perform methods in accordance with various embodiments of the invention. According to a set of embodiments, some or all of the procedures of such methods are performed by the computer or hardware system 500 in response to processor 510 executing one or more sequences of one or more instructions (which might be incorporated into the operating system 540 and/or other code, such as an application program 545) contained in the working memory 535. Such instructions may be read into the working memory 535 from another computer readable medium, such as one or more of the storage device(s) 525. Merely by way of example, execution of the sequences of instructions contained in the working memory 535 might cause the processor(s) 510 to perform one or more procedures of the methods described herein.

The terms “machine readable medium” and “computer readable medium,” as used herein, refer to any medium that participates in providing data that causes a machine to operate in a specific fashion. In an embodiment implemented using the computer or hardware system 500, various computer readable media might be involved in providing instructions/code to processor(s) 510 for execution and/or might be used to store and/or carry such instructions/code (e.g., as signals). In many implementations, a computer readable medium is a non-transitory, physical, and/or tangible storage medium. In some embodiments, a computer readable medium may take many forms, including, but not limited to, non-volatile media, volatile media, or the like. Non-volatile media includes, for example, optical and/or magnetic disks, such as the storage device(s) 525. Volatile media includes, without limitation, dynamic memory, such as the working memory 535. In some alternative embodiments, a computer readable medium may take the form of transmission media, which includes, without limitation, coaxial cables, copper wire, and fiber optics, including the wires that include the bus 505, as well as the various components of the communication subsystem 530 (and/or the media by which the communications subsystem 530 provides communication with other devices). In an alternative set of embodiments, transmission media can also take the form of waves (including without limitation radio, acoustic, and/or light waves, such as those generated during radio-wave and infra-red data communications).

Common forms of physical and/or tangible computer readable media include, for example, a floppy disk, a flexible disk, a hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read instructions and/or code.

Various forms of computer readable media may be involved in carrying one or more sequences of one or more instructions to the processor(s) 510 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer or hardware system 500. These signals, which might be in the form of electromagnetic signals, acoustic signals, optical signals, and/or the like, are all examples of carrier waves on which instructions can be encoded, in accordance with various embodiments of the invention.

The communications subsystem 530 (and/or components thereof) generally will receive the signals, and the bus 505 then might carry the signals (and/or the data, instructions, etc. carried by the signals) to the working memory 535, from which the processor(s) 505 retrieves and executes the instructions. The instructions received by the working memory 535 may optionally be stored on a storage device 525 either before or after execution by the processor(s) 510.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to a particular embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. A method, comprising:
receiving, by an interface system, first input requesting interaction with one or more edge bare metal (“EBM”) servers among a plurality of EBM servers, the plurality of EBM servers each being located at a network edge and being configured to provide bare metal server resources, wherein the interface system provides a uniform interface between the plurality of EBM servers and one or more external systems;
establishing, by the interface system, a connection with each EBM server of the one or more EBM servers;
generating, by the interface system, one or more commands for each of the one or more EBM servers based on the first input, the one or more commands including at least one of one or more instructions or one or more queries, and sending, by the interface system, the one or more commands to each of the one or more EBM servers over the established connection with each EBM server; and
accessing and abstracting, by the interface system, data from the one or more EBM servers via the established connection with each EBM server;
generating, by the interface system, one or more data views based on the abstracted data; and
presenting, by the interface system, the one or more data views to a requesting system among the one or more external systems.

2. The method of claim 1, wherein the one or more external systems each comprises one of a bare metal controller (“BMC”), a server management system, a user interface (“UI”) system, a web portal, a dashboard software application (“app”), a server, or a user device, wherein the one or more external systems communicatively couple with the interface system via one or more networks.

3. The method of claim 1, wherein establishing the connection with each EBM server of the one or more EBM servers comprises establishing, by the interface system, a connection with each EBM server of the one or more EBM servers, using a metal as a service (“MaaS”) instance among a plurality of MaaS instances, the plurality of MaaS instances providing asynchronous application programming interface (“API”) functionality between the interface system and the one or more EBM servers.

4. The method of claim 1, wherein establishing the connection with each EBM server of the one or more EBM servers comprises establishing, by the interface system, a connection with each EBM server of the one or more EBM servers, using one of a secure shell (“SSH”) protocol-based connection or a representational state transfer-based (“RESTful”) API.

5. The method of claim 1, further comprising:
in response to receiving a query from the requesting system, searching, by the interface system, a cache or a local data store for answers to the query, and performing one of:
based on a determination that the cache or the local data store contains answers to the query, sending, by the interface system, one or more first responses to the requesting system, based on the answers contained in the cache or the local data store; or
based on a determination that the cache or the local data store does not contain answers to the query, relaying, by the interface system, the query to the one or more EBM servers over the established connection with each EBM server, and, in response to receiving one or more second responses to the query from at least one EBM server, relaying, by the interface system, the one or more second responses to the requesting system.

6. The method of claim 5, wherein the one or more data views comprise one of the one or more first responses or the one or more second responses.

7. The method of claim 1, wherein at least one of the requested interaction or the one or more commands comprise at least one of enabling hyper-threading in an EBM server, disabling hyper-threading in the EBM server, formatting the EBM server, managing EBM infrastructure, tracking inventory of MaaS instances, monitoring states of MaaS instances, tracking access credentials, performing bare metal compute functionality, building a machine, rebooting a machine, listing servers, listing operating systems, obtaining statuses of MaaS sites, obtaining statuses of active MaaS sites, obtaining operating system (“OS”) images, querying MaaS, forwarding a query payload to a MaaS site and return results from the MaaS site, allocating a server in a specific MaaS site, obtaining machine inventory from a plurality of MaaS sites, deploying a server in MaaS site, releasing a server in MaaS site with a disk erase, updating site information, making changes across multiple MaaS sites with single change using the interface system, formatting drives, installing OSs, setting up user data views, installing packages, or starting network services.

8. The method of claim 1, further comprising:
abstracting, by the interface system, access credentials for the one or more EBM servers; and
based on the abstracted access credentials, providing, by the interface system, at least one external system among the one or more external systems with access to the one or more EBM servers when the at least one external system provides access credentials to the interface system, wherein the at least one external system otherwise lacks access to the one or more EBM servers.

9. The method of claim 8, wherein the interface system provides network connectivity between the at least one external system and the one or more EBM servers over the provided access to the one or more EBM servers, the network connectivity including secure connection.

10. The method of claim 1, wherein the interface system is implemented within at least one of one or more containers or one or more virtual machines (“VMs”) that are hosted on network nodes within an EBM management cluster located within the network edge.

11. The method of claim 1, further comprising:
performing, by the interface system, at least one of collating the data that is accessed and abstracted from the one or more EBM servers, caching the data, obfuscating the one or more EBM servers, handling errors, performing network self-healing, remediating network outages, remediating network failures, or remediating breaches.

12. The method of claim 1, further comprising:
composing, by the interface system, one or more composable infrastructure components virtually into one of the one or more EBM servers.

13. The method of claim 12, wherein the one or more composable infrastructure components comprise one or more graphics processing units (“GPUs”), wherein composing the one or more composable infrastructure components comprises composing, by the interface system, the one or more GPUs virtually into one of the one or more EBM servers using remote direct memory access (“RDMA”) over Ethernet.

14. The method of claim 1, further comprising:
performing, by a server cleanup and monitoring system, server cleanup of an EBM server among the plurality of EBM servers that is no longer providing network services, the server cleanup including at least one of deleting service configurations on the EBM server, rewriting a basic input/output system (“BIOS”) of the EBM server with a replacement BIOS, updating the BIOS of the EBM server, loading a standard configuration on the EBM server, determining whether firmware files on the EBM server are up-to-date, or hardening an operating system of the EBM server to enhance security features of the EBM server.

15. A system, comprising:
a plurality of edge bare metal (“EBM”) servers, the plurality of EBM servers each being located at a network edge and being configured to provide bare metal server resources;
an interface system, comprising:
at least one first processor; and
a first non-transitory computer readable medium communicatively coupled to the at least one first processor, the first non-transitory computer readable medium having stored thereon computer software comprising a first set of instructions that, when executed by the at least one first processor, causes the interface system to:
receive first input requesting interaction with one or more EBM servers among the plurality of EBM servers, wherein the interface system provides a uniform interface between the plurality of EBM servers and one or more external systems;
establish a connection with each EBM server of the one or more EBM servers;
generate one or more commands for each EBM server of the one or more EBM servers based on the first input, the one or more commands including at least one of one or more instructions or one or more queries; and
send the one or more commands to each EBM server of the one or more EBM servers over the established connection with each EBM server.

16. The system of claim 15, wherein the first set of instructions, when executed by the at least one first processor, further causes the interface system to:
access and abstract data from the one or more EBM servers via the established connection with each EBM server;
generate one or more data views based on the abstracted data; and
present the one or more data views to a requesting system among the one or more external systems.

17. The system of claim 15, wherein the first set of instructions, when executed by the at least one first processor, further causes the interface system to:
in response to receiving a query from the requesting system, search a cache or a local data store for answers to the query, and perform one of:
based on a determination that the cache or the local data store contains answers to the query, send one or more first responses to the requesting system, based on the answers contained in the cache or the local data store; or
based on a determination that the cache or the local data store does not contain answers to the query, relay the query to the one or more EBM servers over the established connection with each EBM server, and, in response to receiving one or more second responses to the query from at least one EBM server, relay the one or more second responses to the requesting system.

18. A method, comprising:
receiving, by an interface system, first input requesting interaction with one or more edge bare metal (“EBM”) servers among a plurality of EBM servers, the plurality of EBM servers each being located at a network edge and being configured to provide bare metal server resources, wherein the interface system provides a uniform interface between the plurality of EBM servers and one or more external systems;
establishing, by the interface system, a connection with each EBM server of the one or more EBM servers; and
implementing, by the interface system, interaction between a requesting system among the one or more external systems and each EBM server over the established connection, by abstracting commands from the requesting system for sending to each EBM server and by abstracting data received from each EBM server for presenting to the requesting system.

19. The method of claim 18, wherein abstracting commands from the requesting system for sending to each EBM server comprises generating, by the interface system, one or more commands for each EBM server of the one or more EBM servers based on the first input, the one or more commands including at least one of one or more instructions or one or more queries, and sending, by the interface system, the one or more commands to each EBM server of the one or more EBM servers over the established connection with each EBM server.

20. The method of claim 18, wherein abstracting data received from each EBM server for presenting to the requesting system comprises accessing and abstracting, by the interface system, data from the one or more EBM servers via the established connection with each EBM server, generating, by the interface system, one or more data views based on the abstracted data, and presenting, by the interface system, the one or more data views to a requesting system among the one or more external systems.
